(19) United States
(12) Patent Application Publication
(10) Pub. No.: US 2006/0088051 A1
(43) Pub. Date: Apr. 27, 2006

(54) Method for lossless IPv6 header compression

(76) Inventor: Geoff Mulligan, Colorado Springs, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/235,565

(22) Filed: Sep. 26, 2005

Related U.S. Application Data
(60) Provisional application No. 60/621,253, filed on Oct. 22, 2004.

(51) Int. Cl. H04J 3/16; H04J 3/18; H04J 3/22

(52) U.S. Cl. 370/466; 370/477

(57) ABSTRACT

The present invention provides a method to statelessly compress an IPv6 header from forty octets to as small as or at a minimum of four octets by utilizing information contained in the lower network layers so that the original IPv6 header can be reconstituted as needed without state information maintained from and/or intermediate nodes. By compressing a typical forty octet IPv6 header into at a minimum four octets for transmission across a local area network, battery life for non-line powered local devices can be increased. When the package is to be sent outside of the local area network, the complete IPv6 header packet can be rebuilt prior to transmission.

### CROSS REFERENCE TO RELATED APPLICATION

The present application is based on and claims priority to U.S. Provisional Patent Application Ser. No. 60/621,253, filed on Oct. 22, 2004.

### BACKGROUND OF THE INVENTION

The present invention is related to a method for statelessly reducing the length of network packets communicated using a standard network protocol. More specifically, the present invention is related to a method of compressing the header of the IPv6 format without needing to maintain that state of the connections to enhance the battery life and increase the bandwidth efficiency of wireless communication devices in a local area network (LAN).

Presently, Internet Protocol Version 4 (IPv4)is the most popular and standard protocol in use for the transmission of information over the Internet. Over the past few years, a new standard for addressing and transmitting information over the Internet has been developed and is referred to as IPv6. Although the IPv6 standard has not yet become widely adopted, the IPv6 standard is currently being utilized in numerous applications, has recently been mandated for use by the US Department of Defense, and has become the leading new protocol throughout the Asia Pacific countries. It is anticipated that IPv6 will become the standard for Internet communications in the very near future.

In the previously used IPv4 protocol, the destination and source address fields in the message header were each assigned a 32 bit address. Although the 32 bit address space was generous when first introduced, the number of Internet addresses are beginning to run out because they have been inefficiently allocated. The IPv6 standard has been developed to provide 128 bits of source and destination address space in the packet header. The expansion of the address length from 32 bits to 128 bits means that the new protocol will be able to support approximately 3×10³⁸ addresses or approximately 8×10²⁸ times more addresses. While there are methods that have been published to compress IPv4 and IPv6 headers, these all have required the devices compressing and decompressing the headers to maintain knowledge and state information about the connections and packets being modified. It would therefore be desirable to provide a method for providing header compression without needing to maintain such state information.

Although IPv6 is seen as an improvement of the IPv4 standard, the IPv6 standard increases the amount of data transmitted in the header of each message. Specifically, the header of each message increases from 160 bits (20 bytes/octets) in IPv4 to 320 bits (40 bytes/octets) of information in an IPv6 message. (Throughout this patent the term “octet” will be used to describe 8 bits of data rather than “byte” which is a less precise term.) Although the speed of communication over the Internet is increasing such that this increase in the header length will be seen as insubstantial, the increased header length has a significant effect on the battery life of non-line powered devices and on the transmission time for devices transmitting messages over a personal area network (PAN).

Therefore, it is an object of the present invention to provide a method and means to statelessly compress an IPv6 header from the full 40 octets to a smaller size to reduce the time required to transmit the message, thereby enhancing battery life and reducing transmission time.

### SUMMARY OF THE INVENTION

The present invention is a method of reducing the length of a packet communicated using the IPv6 format. A packet sent using the IPv6 protocol includes an IPv6 header and a data payload, where the IPv6 header has a length of 40 octets. The method of the present invention reduces the overall length of the IPv6 header, and thus reduces the length of the entire packet.

Packets sent over a wide area network (WAN) are transmitted and received using the IPv6 protocol and include an IPv6 header having a length of 40 octets. When the packet is received at a local router or bridge connected to the wide area network, the local router or bridge translates the packet and communicates the packet to any one or more devices in communication with the local router or bridge as part of a local area network (LAN) or a personal area network (PAN). In many contemplated configurations of the local area network, each of the devices communicates with the local router using RF communication. Typically, the RF communication from each of the devices is powered by a self-contained battery. Thus, the amount of time required to transmit each of the packets has a direct impact on the life of the battery within the device.

Prior to transmission of the packet from the local router to any one of the devices that form the LAN or PAN, the local router compresses the IPv6 header. Specifically, the local router removes various portions of the IPv6 header to reduce the IPv6 header from 40 octets to a compressed header length of 4 octets or 20 octets.

During compression of the IPv6 header of packets from sources outside the LAN, the local router removes the version number, traffic class portion, flow label, and destination address prior to transmission of the packet to any one of the devices that form part of the LAN or PAN. Since the version number, traffic class portion and flow label for each of the packets sent between the local router and the devices of the LAN or PAN is the same, these portions of the IPv6 header can be eliminated. Further, since the LAN or PAN encapsulation header (MAC header) or LAN or PAN network layer include the destination address, this portion of the IPv6 header can be eliminated without any loss of information. When the compressed packet is received at any one of the devices or back at the local router, the removed address can be retrieved from the MAC or network header of each message. Thus, the elimination of the address portion from the IPv6 header and the static IPv6 header fields reduces the length of the header prior to transmission without loss of data.

When a compressed packet is received at the local router from any one of the devices that forms part of the LAN or PAN, the local router reconstitutes the IPv6 header by retrieving the source address from the MAC or network header. Additionally, the local router reconstitutes the IPv6 header by reinserting the version number, traffic class portion and flow label back into the compressed header. Once the IPv6 header has been reconstituted, the local router can transmit the uncompressed packet over the WAN, since the IPv6 header is complete.

By utilizing the header compression method described, each of the devices that form part of the local area network can communicate with the local router and communicate between the PAN and LAN devices more efficiently to enhance battery life and reduce band width consumption. Since both the source address and the destination address are included as a portion of the MAC or network headers, the IPv6 header can be reconstituted by the local router prior to transmission of the message over the WAN as necessary.

### BRIEF DESCRIPTION OF THE DRAWINGS

The drawings illustrate the best mode presently claimed for carrying out the invention. In the drawings:

FIG. 1 is a schematic illustration of the communication taking place over wide area network (WAN) and the communication over both hard wired and wireless local area networks (LAN) or personal area networks (PAN);

FIG. 2 is a graphic illustration of the header configuration in the IPv6 format;

FIG. 3 is a graphic illustration of the source and destination address fields in the IPv6 header format;

FIG. 4 is a graphic illustration of the frame format utilized in IEEE 802.15.4 networks;

FIG. 5 is a graphic illustration of the frame format utilized in an Ethernet format;

FIG. 6 is a graphic illustration of the IPv6 header as compressed utilizing the method of the present invention; and

FIG. 7 is a diagram illustrating the reduction in the packet length after compression of the IPv6 header.

### DETAILED DESCRIPTION OF THE PREFERRED EMBODIMENT

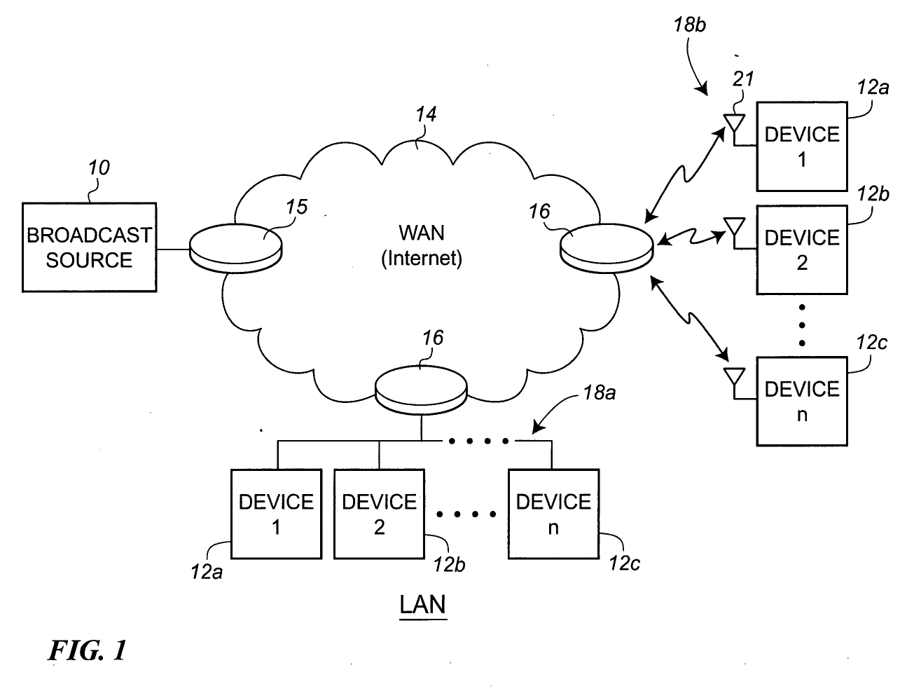

Referring first to FIG. 1, shown therein is an illustration of a common communication method between a source 10 and multiple devices 12a-12c through a wide area network (WAN), such as the Internet 14. In the embodiment illustrated, the source 10 communicates through a router 15 to a local router 16 of either a local area network (LAN) 18a or personal area network (PAN) 18b. In the current embodiment of the invention, the local router 16 is located inside a building and each of the devices 12a-12c communicates with the router 16. As an example, each of the devices 12a-12c may be a smart thermostat, a smart appliance, an air conditioning unit, smoke detector or any other similar device. As illustrated in FIG. 1, each of the devices 12a-12c can communicate first to the local router 16 and then to the source 10 through the Internet 14 such that the source 10 can monitor, control or activate any one of the devices 12a-12c remotely.

As an example, each of the devices 12a-12c can be utilized as part of a complete home network that allows the user to remotely monitor and control multiple devices within the user's home. As an example, the user will be able to remotely monitor and control a thermostat within their home from a remote location. Likewise, the user may be able to turn off or on an appliance, air conditioning unit or other electronic device from a remote location. Additionally, if a hazardous condition detector detects an alarm condition, the alarm condition may be sent over the Internet 14 to alert the homeowner of the alarm condition.

In the network shown in FIG. 1, each of the devices that form part of the local area network 18a or personal area network 18b includes its own unique IP address. Typically, the address of each of the devices 12a-12c within a single LAN or PAN will include a network prefix that is common to all of the devices 12a-12c within the LAN 18a or PAN 18b and a link local address which is generally the MAC address of the device. As can be clearly understood in FIG. 1, if an IP address is assigned to each of the devices 12a-12c in a user's home, the number of IP addresses needed will greatly expand, resulting in the need for the IPv6 network protocol.

In the embodiment of the invention shown in FIG. 1, each of the devices 12a-12c can either be hard-wired to the local router 16 or, alternatively, can include a wireless transmission device 21 to transmit information from the device to the respective router 16. It is contemplated that each of the devices 12a-12c could include a wireless communication device to transmit information by use of an RF signal, although any transmission mechanism may be used. If each of the devices 12a-12c is located remotely from the router 16, the wireless transmission device 21 may be powered by a battery contained within the device itself. Thus, the battery life for each of the devices 12a-12c is a concern and it is desired to maximize the battery life and since the RF network is a shared medium, reducing the network traffic is also a significant benefit.

As can be understood in FIG. 1, when a packet of information is to be transmitted from the broadcast source 10 to one of the remote routers 16 over the Internet 14, the information is sent in a packet utilizing the IPv6 communication protocol, which in turn may be tunneled through an IPv4 Internet connection. Typically, each packet of information includes both a header and an information payload. The IPv6 header provides the information needed to direct the communication from the source 10 to the router 16 and ultimately to the desired device 12a-12c.

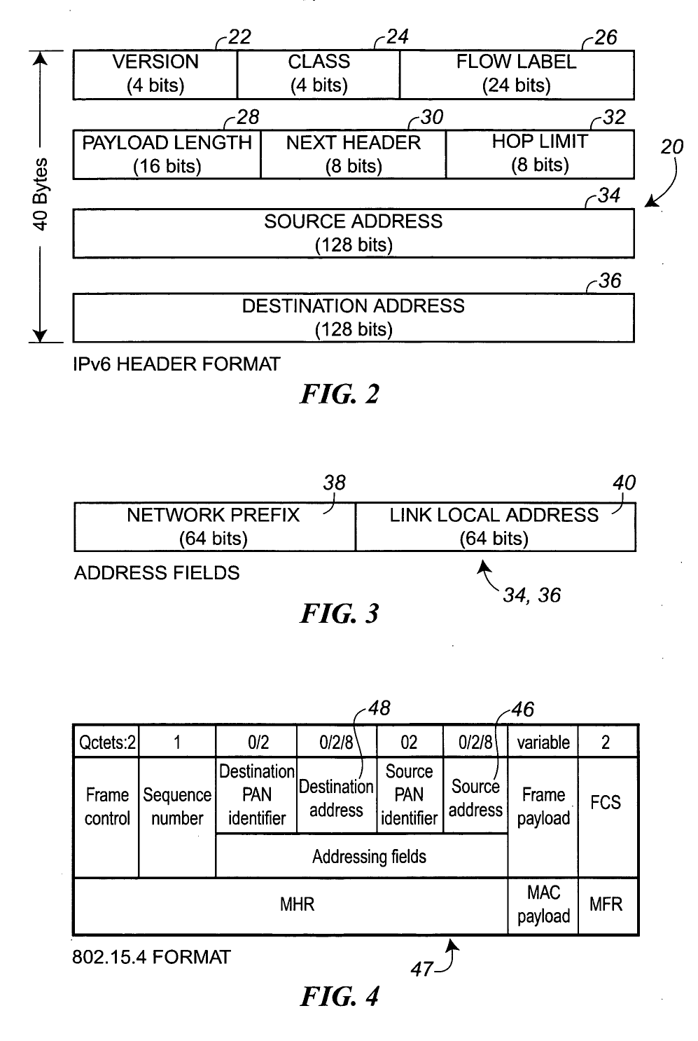

Referring now to FIG. 2, thereshown is the format for the IPv6 header 20. The IPv6 header 20 has a length of forty octets that are divided as shown in FIG. 2. As illustrated, the first portion of the header 20 is the version number 22 that defines the version of the Internet Protocol and includes four bits. The next section of the header 20 is the traffic class 24 that also includes four bits. Following the traffic class 24 is a flow label 26 that is twenty-four bits in length. The next section of the header is a payload length 28, which is a sixteen bit segment. The payload length 28 is followed by the next header segment 30 having a length of eight bits, followed immediately by the hop limit 32 that includes eight bits. Thus, the portion of the header 20 leading up to the address segments comprises one hundred sixty bits of information.

Following the initial portion of the header, the IPv6 header format includes a source address 34 which has a length of one hundred twenty eight bits. Likewise, the destination address 36 is also a one hundred twenty eight bit address. As described previously, the IPv6 header format 20 expands both the source address 34 and the destination address 36 to a one hundred twenty eight bit address as compared to the IPv4 format in which both the source address and the destination address were thirty-two bit sections. As can be understood in FIG. 2, the entire header 20 in the IPv6 format is forty octets in length and precedes the information payload that is transmitted over the Internet.

Referring back to FIG. 1, when the packet is received at the local router 16, the local router 16 directs the information to the desired device 12a-12c. However, since the devices 12a-12c are all contained on a common LAN 18a or PAN 18b, much of the address information contained within the IPv6 header 20 is unnecessary for assuring the correct transmission of information within the LAN/PAN. Since the IPv6 header is much longer than the prior IPv4 header information, it is desired to provide a method and system for compressing the header information to minimize the amount of time required by the wireless transmission devices to transmit the entire information packet. However, it should also be understood that the header information cannot be compressed to the point at which relevant address and source information is lost, since the information may need to be sent back over the Internet 14.

When an packet is received at the local router 16, the local router 16 can determine the device 12a-12c to which the packet is to be directed from the header information. However, if the local router 16 is to communicate with any of the devices 12a-12c using wireless communication, the forty octet header format increases the amount of time that the wireless transmission devices must be active to transmit the packet including the IPv6 header 20. Since each local router 16 communicates with the devices 12a-12c that form part of the LAN 18a or PAN 18b, much of the information included in the IPv6 header 20 is either a constant value or is included somewhere else in the packet, either the MAC or network header.

Referring back to FIG. 2, in a typical IPv6 header 20, the version number field 22 is set to the number six (6) which defines the version of the protocol. Since the local router 16 will be communicating using only IPv6, the version field 22 can be compressed to zero bits without the loss of any information. In addition, the traffic class field 24 and the flow label 26 will always be set to zero for the communication between the local server 16 and the individual devices 12a-12c. Thus, both the traffic class field 24 and the flow label 26 can be set to zero and thus compressed to zero bits.

The next three fields, including the payload length 28, the next header field 30 and the hop limit 32 must be left intact and thus are not compressed. Thus, the initial six fields of the IPv6 header 20 can be compressed to encompass only four octets, rather than the eight octets required in the full, uncompressed IPv6 header 20.

As illustrated in FIG. 2, both the source address field 34 and the destination address field 36 each contain one hundred twenty eight bits of data. As shown in FIG. 3, the first sixty-four bits of each address 34, 36 is a network prefix 38 that is fixed and assigned external to the local or personal area network 18a and 18b. The network prefix 38 is common to all of the devices 12a-12c on the LAN or PAN. Thus, for communication between the local router 16 and the individual devices 12a-12c, the network prefix value 38 can be compressed to zero bits for all packets that are transmitted within the LAN or PAN. For all transmissions being delivered either to or from the LAN 18 over the WAN 14, the network prefix 38 must be present in the source address for packets being sent from outside the PAN and in the destination address for packets being sent to destinations outside the PAN.

As illustrated in FIG. 3, the second sixty-four bits of each address field is the link local address 40. A link local address 40 is the address that directs the message to the individual device 12a-12c that form part of the local area network area 18a or the personal area network 18b. Although the link local address 40 is included in both the source address 34 and the destination address 36 in the IPv6 header 20, this information is also included in other portions of the packet.

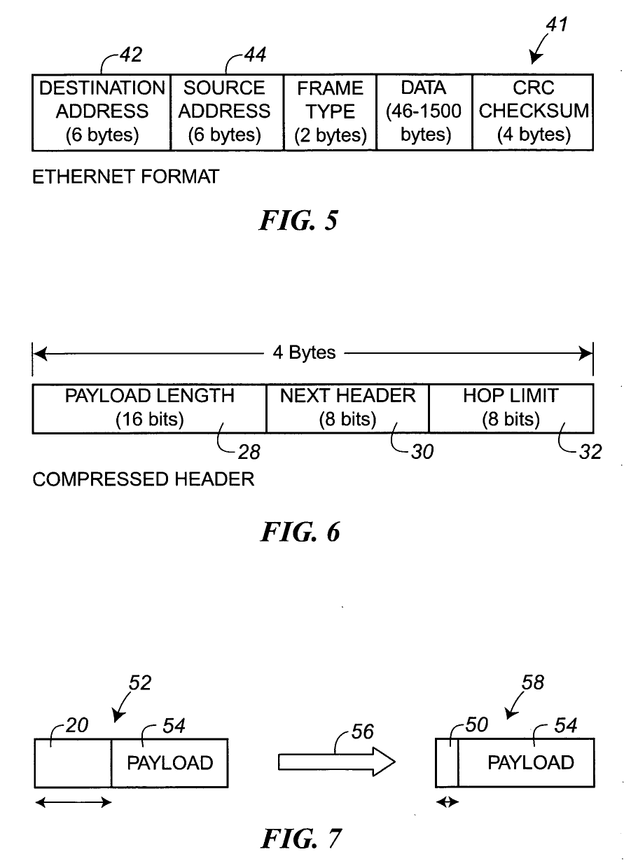

As an example, when the packet is being sent using the standard Ethernet payload format 41 shown in FIG. 5, the Ethernet forty-eight bit destination address 42 and forty-eight bit source address 44 are the same as the link local addresses in the IPv6 header when extended. The addresses 42, 44 are IEEE sixty-four bit extended to correspond to the link layer address 40 included as part of either the source address 34 or the destination address 36 in the IPv6 header 20. Since both the destination address 42 and the source address 44 are included as part of the MAC or network headers, both the source address 34 and the destination address 36 in the IPv6 header 20 can be compressed to zero bits when transmitting between devices on the LAN or PAN. When sending packets to a destination outside the LAN or PAN the destination IPv6 address is left intact and when sending packets into the LAN or PAN from sources outside the PAN or LAN the source address is left intact

Referring now to FIG. 4, thereshown is the packet format 47 for use in an 802.15.4 network. In this type of network, the Link Layer frame includes a source link layer address 46 and a destination link layer address 48. In the preferred embodiment, the addresses in the link layer are complete sixty-four bit IEEE EIU addresses and do not need forty-eight to sixty-four bit address extensions. Thus, the link layer addresses 40 used in the IPv6 header are also being carried in the link layer of the payload format 47 and, therefore, can be compressed in the IPv6 header to zero octets during transmission within the local area network 18. In 802.15.4 networks that utilize multi-hop capabilities, the destination link address will be carried in the network layer and can therefore be compressed just as the source address can be. The link layer address can be statelessly reconstructed from information in the link or network layer and thus can be compressed from the IPv6 header.

FIG. 6 shows the compressed header 50 created utilizing the method of the present invention. As illustrated, the compressed header 50 has a length of only four octets and includes the payload length 28, which is two octets, the next header section 30, which is one octet, and the hop limit 32 which is also one octet. The compressed header 50 can be utilized for communicating information between the local router 16 and the devices 12a-12c that form part of the LAN 18a or the PAN 18b. The remaining address information and other fields in the standard IPv6 header 20 can be compressed out of the IPv6 header to create the compressed header 50. As described previously, the destination address 48 and the source address 46 can be recovered from the link layer or network headers, as described in FIGS. 4 and 5.

When a packet is to be sent outside of the local network 18a or 18b, either to other networks or to another local device, the complete IPv6 header can be rebuilt statelessly by reversing the above compression method and inserting the network prefix 38 and link layer address 40 into the source and destination address fields 34, 36. In addition to reinserting the network prefix 38 and the link layer address 40, the IPv6 packet header 20 is rebuilt by reinserting the version number 22, the traffic class 24 and the flow label 26, which were each removed during the compression process. Once the IPv6 header 20 has been reconfigured, the packet can be sent across the WAN 14 in a conventional manner.

As an example, if any one of the devices 12a-12c needs to communicate over the WAN 14 to the broadcast source, the device 12a-12c communicates a packet initially to the local router 16. When the local router 16 receives the packet from one of the devices 12a-12c, this packet includes a compressed header. Initially, the local router 16 decompresses the compressed header by statelessly reconstituting the header to the IPv6 packet header by reinserting the version block 22, the traffic class 24, the flow label 26 and the source address 34. As described previously, the source address 34 can be recovered from MAC or network headers of the packet received from the device 12a-12c.

Once the header of the packet has been reconstituted to be the fully IPv6 header 20, the packet can be transmitted by the local server 16 over the WAN 14.

Referring now to FIG. 7, thereshown is an original packet 52 having the uncompressed IPv6 header 20 and an information payload 54. The original packet 52 includes the forty octet header 20 and a conventional payload 54. As an example, the payload 54 could include a thirty octet payload such that the entire packet 52 is seventy octets. When such an packet 52 is transmitted, 57.14% (40 octets of 70 octets) of the transmission time is used to transmit the uncompressed header 20. A thirty octet payload would be a typical size for PAN data.

After compression, as illustrated by arrow 56, the compressed packet 58 has the compressed header 50 and the same payload 54. As described previously, the compressed header 50 has a total length of four octets, as compared to the uncompressed header 20 having a length of forty octets. Since the payload 54 remains the constant thirty octet length, the compressed packet 58 has a total length of thirty-four octets. When such a compressed packet 58 is transmitted, only approximately 11.76% (4 octets of 34 octets) of the transmission time is required for the transmission of the compressed header 50, as compared to the 57.14% required when the header 20 is uncompressed.

As can be understood by the above description, when the transmission of the packets is occurring using RF transmission powered by a storage battery, the reduction in the amount of time required to transmit the header is a significant improvement as compared to an uncompressed header. In addition to saving battery life, the compression of the IPv6 header reduces the amount of bandwidth required for transmission and increases through-put significantly.

As the above description indicates, the IPv6 header, which is typically forty octets, can be compressed to four octets when communicating intraLAN or intraPAN (within the LAN or PAN). When the source or destination of the packet is outside the PAN or LAN, the respective address in the IPv6 header is not compressed and the resulting packet size is twenty octets. These reductions in the header 20 allows each of the local devices 12a-12c to reduce the transmission time for communication both within the local area network 18a or personal area network 18b and outside the LAN or PAN. Since the address information is carried within each message in the link layer, the source and destination fields can be rebuilt statelessly prior to transmission of the information over the WAN 14. The reduction in the size of the IPv6 header will have a significant effect on the battery life of the remote devices 12a-12c as well as channel contention and interference.

Various alternatives and embodiments are contemplated as being within the scope of the following claims particularly pointing out and distinctly claiming the subject matter regarded as the invention.

What is claimed is:

1. A method of statelessly reducing the length of a packet configured using a network communication format, the packet including a header and an information payload, the method comprising the steps of:
receiving the packet from a wide area network (WAN) at a local router of a local area network (LAN) including at least one device in communication with the local router;
compressing the header of the information payload prior to transmission of the packet from the local router to the at least one device; and
transmitting the packet including the compressed header to the at least one device.

2. The method of claim 1 wherein the step of compressing the header includes:
removing a version number from the header;
removing a traffic class portion of the header;
removing a flow label from the header; and
removing a destination address from the header.

3. The method of claim 2 wherein the header of the packet has a length of 40 octets and the compressed header has a length of 20 octets.

4. The method of claim 2 further comprising the steps of:
receiving the packet from the local router at one of a device; and
statelessly decompressing the header by inserting the version number, traffic class and flow label and retrieving the destination address from a MAC or a network header of the packet.

5. The method of claim 1 wherein the at least one device includes an RF transmitter and the response packets are transmitted from the device to the local router using the RF transmitter.

6. The method of claim 1 further comprising the steps of:
receiving a local packet at the local router from the at least one device, the local packet having a compressed header and an information payload;
decompressing the compressed header at the local router prior to transmission of the local packet over the WAN; and
transmitting the local packet including the decompressed header over the WAN.

7. The method of claim 4 further comprising the steps of:
receiving a packet at the local router from the at least one device, the packet having a compressed header and an information payload;
statelessly decompressing the compressed header at the local router prior to transmission of the packet over the WAN; and
transmitting the packet including the decompressed header over the WAN.

8. The method of claim 6 wherein the step of decompressing the compressed header at the local router includes the steps of:
recovering the source address from MAC or network headers of the packet; and
reinserting the version number, traffic class, flow label, and source address into the compressed header to reconstitute the header.

9. A method of statelessly reducing the length of a packet communicated using IPv6 format, the packet including an IPv6 header and an information payload, the method comprising the steps of:
receiving the packet from a wide area network (WAN) at a local router of a local area network (LAN) or personal area network (PAN) including a plurality of devices in communication with the local router;
compressing the IPv6 header of the information payload prior to transmission of the packet from the local router to any one of the plurality of devices; and
transmitting the packet including the compressed header to at least one of the plurality of devices.
receiving a response packet at the local router from any one of the plurality of devices, the response packet having a compressed header and an information payload;
statelessly decompressing the compressed header at the local router prior to transmission of the response packet over the WAN; and
transmitting the response packet including the decompressed header over the WAN.

10. The method of claim 9 wherein the step of compressing the IPv6 header includes:
removing a version number from the IPv6 header;
removing a traffic class portion of the IPv6 header;
removing a flow label from the IPv6 header; and
removing a destination address from the IPV6 header.

11. The method of claim 10 wherein the IPv6 header of the packet has a length of 40 octets and the compressed header has a length of 16 octets.

12. The method of claim 9 further comprising the steps of:
receiving the packet from the local router at one of a plurality of devices; and
retrieving the destination address from the MAC or network header of the packet.

13. The method of claim 9 wherein each of the plurality of devices includes an RF transmitter and the response packets are transmitted from the devices to the local router using the RF transmitted.

14. The method of claim 10 wherein the step of statelessly decompressing the compressed header at the local router includes the steps of:
recovering the destination address from the MAC or network header of the packet; and
reinserting the version number, traffic class, flow label, and destination address into the compressed header to reconstitute the IPv6 header.

15. In a local area network having a router and a plurality of devices in communication with the router, a method of compressing a packet having an IPv6 header and an information payload, the IPv6 header having a version number, a traffic class portion, a flow label, a payload length, a next header, a hop limit, a source address and a destination address, the method comprising the steps of:
receiving the packet at the local router;
removing the version number, the traffic class portion, the flow label, the source address and the destination address from the IPv6 header at the local router to create a compressed header;
transmitting the packet including the compressed header to at least one of the plurality of devices; and
determining the source address and the destination address from the MAC or network headers at the device.

16. The method of claim 15 wherein the version number, traffic class section and the flow label are constant for the communication between the server and the plurality of devices.
